(19) United States
(12) Patent Application Publication
(10) Pub. No.: US 2021/0276024 A1
(43) Pub. Date: Sep. 9, 2021

(54) COMBINED COLLECTOR FOR ZINC OXIDE ORE FLOTATION AND USE THEREOF

(71) Applicant: Central South University, Changsha (CN)

(72) Inventors: Qing SHI, Changsha (CN); Guofan ZHANG, Changsha (CN); Leming OU, Changsha (CN)

(21) Appl. No.: 17/105,990

(22) Filed: Nov. 27, 2020

(30) Foreign Application Priority Data
Mar. 5, 2020 (CN) 202010147567.7

(51) Int. Cl. B03D 1/016; C01G 9/02

(52) U.S. Cl. CPC B03D 1/016; B03D 2201/007; B03D 2201/02; C01G 9/02

(57) ABSTRACT

The present disclosure discloses a combined collector for zinc oxide ore flotation, including the following components in percentage by mass: 60-95 wt % of a fatty acid, 0-10 wt % of a hydroxamic acid and 5-35 wt % of a mercaptobenzothiazole. In the flotation process of zinc oxide ore, due to the use of the combined collector of the present disclosure, it is not required to deslime. On the premise of ensuring the zinc grade in the zinc concentrate, the flotation recovery rate of the zinc concentrate is improved and the zinc grade of mineral processing tailings is reduced by using the combined collector, thereby reducing the loss of zinc metal.

### CROSS REFERENCE TO RELATED APPLICATION

This application claims the priority of Chinese Patent Application No. 202010147567.7, entitled “Combined collector for zinc oxide ore flotation and use thereof” and filed with the China National Intellectual Property Administration on Mar. 5, 2020, which is incorporated herein by reference in its entirety.

### TECHNICAL FIELD

The present disclosure relates to a combined collector for zinc oxide ore flotation and a use thereof, and belongs to the field of mineral flotation reagents.

### BACKGROUND

The amount of zinc metal used in modern industry is second only to metals such as iron, aluminum and copper. It is mainly used in the galvanizing industry, machinery manufacturing industry and battery fields, and plays a very important role. China is relatively rich in zinc ore resources. At present, most of the mines are mainly engaged in the exploitation and separation of sulfide ores, and only a few mines can utilize high-grade oxidized ores by leaching method, while low-grade zinc oxide ore and mixed oxide-sulfide zinc ore are typical complex and refractory resources. In view of this, it is urgent to develop new high-efficiency mineral processing and metallurgical technologies.

It is reported that the mineral processing for treating low-grade zinc oxide ores mainly includes flotation process, gravity-flotation combined process, magnetic-flotation combined process, flotation-leaching combined process, roasting-flotation combined process and so on. Among them, the commonly used flotation methods comprise sulfide-amine method, sulfide xanthate method, fatty acid method, mercaptan flotation method, chelating agent flotation method and so on, each of these methods has its own characteristics; however, due to the fact that low-grade zinc oxide tends to be serious argillation, zinc exists in various mineral forms, the properties of useful minerals (such as smithsonite) are very similar to those of gangue minerals (such as calcite and dolomite), and the ore slurry inevitably has complex ion components, low-grade zinc oxide ore is poor in flotation effect, its industrial actual production process is unstable, and most of its resources have not been utilized.

Mercaptobenzothiazole is a general vulcanization accelerator that is widely used in various rubber industries, but it has also been reported to be used as a collector. CN 109158214A discloses a flotation separation process of copper zinc sulfide ore, in which the combined collector used contains 2-mercaptobenzothiazole, which maintains the high selectivity of a reagent while reducing the sensitivity to sphalerite, and realizes the selective collection of copper sulfide ore, making the reagent have a good grade and recovery. A. M. Marabini et al. (Thermodynamic approach for the evaluation of the reactivity of mercaptobenzothiazole reagents with Pb and Zn cations; correlation with results of flotation, Metallic Ore Dressing Abroad, Nov., 2008) reported the thermodynamic calculation of some condition constants of the coordination of mercaptobenzothiazole (MBT) reagent with the lead-zinc cation to form complexes, in order to evaluate the collection effect of the MBT reagent on the lead-zinc ore. From the calculation results, it can be concluded that MBT forms a stable complex with lead and has a selectivity to lead, while the complex formed by MBT and zinc has a low stability constant value.

### SUMMARY

In view of the problems in the prior art, an objective of the present disclosure is to provide a combined collector for zinc oxide ore flotation. In the flotation, due to the use of the combined collector, it is not required to deslime. On the premise of ensuring the zinc grade in the zinc concentrate, the flotation recovery rate of the zinc concentrate is improved and the zinc grade of mineral processing tailings is reduced by using this combined collector, thereby reducing the loss of zinc metal.

In order to achieve the technical objective, the present disclosure adopts the following technical scheme:

A combined collector for zinc oxide ore flotation, comprising the following components in percentage by mass:
60-95 wt % of a fatty acid;
0-10 wt % of a hydroximic acid; and
5-35 wt % of a mercaptobenzothiazole.

In some embodiments, the combined collector comprises the following components in percentage by mass:
70-85 wt % of a fatty acid;
5-10 wt % of a hydroximic acid; and
10-20 wt % of a mercaptobenzothiazole.

In some embodiments, the fatty acid is at least one selected from the group consisting of oleic acid, oleate, palmitic acid, palmitate, stearic acid, stearate, lauric acid, laurate, palmitic acid and palmitate.

In some embodiments, the hydroximic acid is at least one selected from the group consisting of benzylhydroximic acid, salicylhydroxamic acid and alkyl hydroxamic acid.

In some embodiments, the mercaptobenzothiazole is at least one selected from the group consisting of 2-mercaptobenzothiazole and sodium 2-mercaptobenzothiazole.

The present disclosure also provides a use of the above combined collector, comprising:
grinding a zinc oxide ore in the form of run-of-mine ore to an extent that the content of the ore with a particle size of 0.074 mm or less is not less than 60%, subjecting the ground zinc oxide ore to a pulp conditioning to a pH of 8-12, then adding 500-3500 g/t of an inhibitor; adding 400-1200 g/t of the combined collector, carrying out another pulp conditioning and a flotation, to obtain a zinc oxide concentrate.

The inhibitor in the present disclosure is an inhibitor commonly used in the existing mineral processing of zinc oxide ore, for example, being at least one of conventional inhibitors such as water glass, sodium hexametaphosphate, dextrin, lignosulfonate, sodium citrate and sodium humate.

Different from the prior art, in the present disclosure, the mercaptobenzothiazole can reduce the sensitivity to sphalerite and realize selective collection of copper sulfide minerals; the mercaptobenzothiazole can form stable complex with lead and is selective to lead, while it is reported that the complex formed by conventional collectors and zinc has a low stability constant; however, by adding the mercaptobenzothiazole to the conventional collectors of zinc oxide ores (such as fatty acids and hydroximic acids) and strictly controlling the proportion of each component, it is unexpectedly found by the inventor that the mercaptobenzothiazole can improve the collection performance of the combined collector to zinc, improve the flotation recovery rate of zinc concentrate under the premise of guaranteeing the zinc grade in zinc concentrate, and bring about good separation effect.

On the premise of ensuring the zinc grade in the zinc concentrate, the combined collector of the present disclosure can improve the flotation recovery rate of the zinc concentrate, reduce the zinc grade of tailings, and further reduce the loss of zinc metal.

### DETAILED DESCRIPTION

Hereinafter, the present disclosure will be described in further detail with reference to specific examples, but the scope of the present disclosure is not limited thereto. In the examples of the present disclosure, the contents herein are all expressed by mass, unless otherwise specified.

### Example 1

This example took a zinc oxide ore in the form of run-of-mine ore as the object, the ore sample contained about 7.60% of zinc, wherein the oxidation rate of zinc is about 70%, the main gangue minerals are quartz, calcite, chlorite, mica, gypsum and so on. The used combined collector of the present disclosure consisted of: 75 wt % of sodium oleate, 5 wt % of benzylhydroximic acid and 20 wt % of sodium 2-mercaptobenzothiazole.

The run-of-mine ore was ground to an extent that the content of the ore with a particle size of 0.074 mm or less is 85%, Sodium carbonate was first added for a pulp conditioning to a pH of about 9.5, then 3000 g/t of an inhibitor (which is a combined inhibitor consisting of 500 g/t of water glass, 500 g/t of a soluble starch, 1000 g/t of a lignosulfonate and 1000 g/t of a phosphate) was added, then 1000 g/t of the combined collector was added for a stirred pulp conditioning, and the resulting system was subjected to a flotation for 7 min, to obtain a zinc concentrate. The test results were shown in Table 1.

### Example 2

The conditions were identical to those of Example 1 except that the combined collector consisted of 80 wt % of sodium oleate and 20 wt % of sodium 2-mercaptobenzothiazole, and was used in an amount of 1000 g/t. The test results were shown in Table 1.

### Example 3

The conditions were identical to those of Example 1 except that the combined collector consisted of 80 wt % of sodium oleate, 10 wt % of benzylhydroximic acid and 10 wt % of sodium 2-mercaptobenzothiazole, and was used in an amount of 1000 g/t. The test results were shown in Table 1.

### Comparative Example 1

The conditions were identical to those of Example 1 except that the combined collector consisted of 95 wt % of sodium oleate and 5 wt % of benzylhydroximic acid, and was used in an amount of 1000 g/t. The test results were shown in Table 1.

### Comparative Example 2

The conditions were identical to those of Example 1 except that the combined collector consisted of 55 wt % of sodium oleate, 5 wt % of benzylhydroximic acid and 40 wt % of sodium 2-mercaptobenzothiazole, and was used in an amount of 1000 g/t. The test results were shown in Table 1.

TABLE 1
Flotation test results for low-grade zinc oxide ores

| | | Yield | Zn grade | Zn recovery rate |
|---|---|---|---|---|
| Examples | Product Name | (%) | (%) | (%) |
| Example 1 | Zinc | 30.87 | 21.85 | 88.28 |
| | concentrate | | | |
| Example 2 | Zinc | 35.93 | 19.05 | 88.75 |
| | concentrate | | | |
| Example 3 | Zinc | 29.12 | 23.13 | 87.50 |
| | concentrate | | | |
| Comparative | Zinc | 32.65 | 20.21 | 86.84 |
| Example 1 | concentrate | | | |
| Comparative | Zinc | 42.95 | 16.60 | 91.47 |
| Example 2 | concentrate | | | |

What is claimed is:

1. A combined collector for zinc oxide ore flotation, comprising the following components in percentage by mass:
60-95 wt % of a fatty acid;
0-10 wt % of a hydroximic acid; and
5-35 wt % of a mercaptobenzothiazole.

2. The combined collector for zinc oxide ore flotation as claimed in claim 1, wherein the combined collector comprises the following components in percentage by mass:
70-85 wt % of a fatty acid;
5-10 wt % of a hydroximic acid; and
10-20 wt % of a mercaptobenzothiazole.

3. The combined collector for zinc oxide ore flotation as claimed in claim 1, wherein the fatty acid is at least one selected from the group consisting of oleic acid, oleate, palmitic acid, palmitate, stearic acid, stearate, lauric acid, laurate, palmitic acid and palmitate.

4. The combined collector for zinc oxide ore flotation as claimed in claim 1, wherein the hydroximic acid is at least one selected from the group consisting of benzylhydroximic acid, salicylhydroxamic acid and alkyl hydroxamic acid.

5. The combined collector for zinc oxide ore flotation as claimed in claim 1, wherein the mercaptobenzothiazole is at least one selected from the group consisting of 2-mercaptobenzothiazole and sodium 2-mercaptobenzothiazole.

6. A use of the combined collector for zinc oxide ore flotation as claimed in claim 1, comprising:
grinding a zinc oxide ore in the form of run-of-mine ore to an extent that the content of the ore with a particle size of 0.074 mm or less is not less than 60%, subjecting the ground zinc oxide ore to a pulp conditioning to a pH of 8-12, then adding 500-3500 g/t of an inhibitor; adding 400-1200 g/t of the combined collector, carrying out another pulp conditioning and a flotation, to obtain a zinc oxide concentrate.

7. The combined collector for zinc oxide ore flotation as claimed in claim 2, wherein the fatty acid is at least one selected from the group consisting of oleic acid, oleate, palmitic acid, palmitate, stearic acid, stearate, lauric acid, laurate, palmitic acid and palmitate.

8. The combined collector for zinc oxide ore flotation as claimed in claim 2, wherein the hydroximic acid is at least one selected from the group consisting of benzylhydroximic acid, salicylhydroxamic acid and alkyl hydroxamic acid.

9. The combined collector for zinc oxide ore flotation as claimed in claim 2, wherein the mercaptobenzothiazole is at least one selected from the group consisting of 2-mercaptobenzothiazole and sodium 2-mercaptobenzothiazole.
